(19) United States
(12) Patent Application Publication
(10) Pub. No.: US 2022/0127687 A1
(43) Pub. Date: Apr. 28, 2022

(54) DEVICE, EXCHANGE UNIT, KIT, AND METHOD FOR REDUCING THE ODOR OF TANNED LEATHER

(71) Applicant: TFL Ledertechnik GmbH, Rheinfelden (DE)

(72) Inventors: Jens Fennen, Grenzach-Wyhlen (DE); Rodolfo Ampuero Allen, Lahnstein (DE); Nina Schulte-Gauczinski, Freiburg (DE); Lorenzo Mejias Llanos, Weil am Rhein (DE)

(73) Assignee: TFL Ledertechnik GmbH, Rheinfelden (DE)

(21) Appl. No.: 17/311,912

(22) PCT Filed: Dec. 9, 2019
(86) PCT No.: PCT/EP2019/084186

§ 371 Date: Jun. 8, 2021

(30) Foreign Application Priority Data
Dec. 10, 2018 (DE) 10 2018 131 624.0

(51) Int. Cl. C14C 15/00

(52) U.S. Cl. CPC C14C 15/00

(57) ABSTRACT

The invention relates to a device for reducing the odor of tanned leather, comprising a treatment chamber, which is designed to dry tanned leather and/or treat dried leather, and at least one odor reducing reservoir, wherein the at least one odor reducing reservoir has at least one odor-neutralizing substance, and a gas-exchange connection is provided between the treatment chamber and the odor reducing reservoir.

The invention relates to a device for reducing the odor of tanned leather.

For producing real leather from hides, as a rule a large number of different chemicals are required. After tanning, leather often has a relatively strong odor, owing to the use of chemicals, as well as the inherent odor of leather, and many consumers perceive this as unpleasant. In particular, in the case of leather trim for passenger cars, an unpleasant odor of the interior due to the leather used is a particular problem. Increasingly, consumers demand odor-neutral real leather.

However, the problem of the unpleasant odor of tanned leather has even been intensified in recent years by the introduction of increasingly resource-sparing and in particular water-saving tanning processes and tanning systems. This may for example be attributed to the fact that the hides or the leather are washed less often in the new, more resource-sparing processes, in order to gain an overall reduction in water consumption in leather manufacture. A further aspect is energy-saving drying of leather, as drying of tanned leather is now often carried out at lower temperatures than previously, so that sources of odors evaporate less intensively during heat treatment. For these reasons, tanned leather now often has a stronger unpleasant odor than before.

The aim of the invention is therefore to reduce the unpleasant odor of tanned leather, wherein this is to be done in a resource-sparing and sustainable manner.

The aforementioned aim is achieved according to the invention with the features of independent claim 1. In particular, according to the invention, for achieving said aim, a device is proposed for reducing the odor of tanned leather, comprising a treatment space, which is equipped for drying tanned leather and/or for treating dry leather, and at least one odor-reduction reservoir, wherein the at least one odor-reduction reservoir has at least one odor-neutralizing substance, wherein a gas-exchange compound is interposed between the treatment space and the odor-reduction reservoir. With the device according to the invention it is possible for odor reduction to be undertaken during the usual process steps required in leather manufacture. This has the advantage that integration of odor reduction is possible in the usual procedure for leather production, without having to include additional time for further steps. A further advantage of the device according to the invention is that odor reduction can thus be carried out during a dry phase. The term “dry phase” may then refer to the fact that the leather in this phase is not present in water or an aqueous solution (corresponding to “liquid phase”), such as for example a liquor, but in a space that is filled mainly or almost completely with gas, for example air. Odor reduction can therefore take place exclusively on the basis of gas exchange. Therefore odor reduction of leather can thus take place without addition of water and/or water consumption. Therefore a particularly resource-sparing and sustainable odor reduction can take place by means of the device. According to a variant, which is not to be excluded by the foregoing, it may be envisaged that the odor-neutralizing substance is present in aqueous solution. In this connection, dry phase may therefore relate to the state of the leather.

According to a variant, what is described in the preceding paragraph moreover does not exclude that the treatment space has a nebulizer device, which is arranged for releasing a fine mist of small liquid droplets within the treatment space and/or the gas exchange line. The nebulizer device may for example serve for keeping the moisture content of the treated leather almost constant during the treatment time. The moisture content of leather may be from 10-20%, preferably about 16%. Finally, even dry leather is not water-free and tends to suffer damage below a critical moisture content. Furthermore, owing to the at least one nebulizer device, unintentional dust formation can be avoided, which may occur below a critical moisture content. The nebulizer device of the treatment space may for example be configured and/or used for releasing water, and in particular for spraying water. Alternatively or additionally, the nebulizer device may be configured and/or used for distributing additives, in particular in aqueous solution, on the leather, by releasing them as a mist in the treatment space.

An odor-neutralizing substance in the sense of the invention may generally relate to sorbent substances (sorbents). In particular, this may therefore include substances such as absorbents, which make adsorption and/or absorption of odors possible. Odors may thus be bound by the odor-neutralizing substance. Alternatively or additionally, the term odor-neutralizing substance may also include substances that break down odors actively, for example by reactions and/or by complexing.

Advantageous embodiments of the invention are described hereunder, which, either alone or in combination with the features of other optional embodiments, may be combined with the features as claimed in claim 1.

According to one embodiment, the at least one odor-reduction reservoir may be arranged outside the treatment space. Moreover, it may in particular be envisaged that at least one gas exchange line is provided between the treatment space and the at least one odor-reduction reservoir. This has the advantage that the treatment of leather in the treatment space can take place simultaneously with odor reduction, without the for example conventionally configured treatment space having to be reconfigured for carrying out the odor reduction. This makes it even easier to incorporate odor reduction in existing processes for leather manufacture. For example, during drying of leather, often gas exchange is provided, so that the leather can be dried more quickly, for example to lead away moisture that is given up to the surroundings.

According to a further embodiment, the treatment space may be of movable configuration, so that leather placed therein is carried along during operation. Owing to the movement of the leather, more effective odor reduction is possible, because more difficultly accessible sources of odors are also treatable.

Alternatively or additionally to the aforementioned embodiments, the treatment space may be configured as a drum tumbler for tumbling dry leather. For example, it may be configured as a tumbling drum or drum tumbler. Alternatively or additionally, the treatment space or a further treatment space may be configured as a drying chamber for drying tanned leather. For example, the treatment space may be configured as a drying tunnel.

According to a variant, it may be envisaged that an opening of the treatment space is closable, in particular is closable to be air-tight. This may for example take place by means of a closure unit, which is for example configured as a door or hatch. This may provide better prevention of particles, whirled up by the treatment, escaping and being inhaled by a person in the vicinity.

In a further embodiment it may be envisaged that the at least one odor-reduction reservoir is arranged in a chamber separated from the treatment space, which is connected via at least one gas exchange line, for example the aforementioned gas exchange line or a further gas exchange line, to the treatment space. In the working position, the chamber may be closed or closable. For example, shut off at least toward the exterior and/or toward the treatment space. It may therefore be envisaged that a closed or closable system is configured from the treatment space, gas exchange line and chamber, in which a gas stream, in particular a circulating gas stream, can be produced. In operation, i.e. with movement of the treatment space, the chamber is not also moved, but remains stationary.

In order to reduce the particle loading that may develop in the treatment space during the treatment, a filter, in particular a particle filter, may be arranged in a chamber, for example the aforementioned chamber or an additional chamber. Alternatively or additionally, a filter and/or a further filter may be arranged in a gas exchange line, for example the aforementioned gas exchange line. In this way it is possible to filter out particles from the gas stream, so that the dust burden, in particular within the treatment space, can be reduced. Moreover, by means of the filter it is possible for precipitating solids, which are for example released by a nebulizer device within the treatment space and/or the gas exchange line, for example in aqueous solution, to be removed from the gas stream. This may in particular prevent deposition of the solids on the leather. The nebulizer device may be arranged in the direction of the gas stream, i.e. before the filter. For example, odor-reducing substances, such as cyclodextrins in particular, may be filtered out by the at least one filter. This may provide better prevention of deposition of these substances on the leather. Moreover, there may be an overall reduction in the formation of dust, if at least one filter is arranged in the gas stream.

In order to be able to accelerate the gas exchange between the odor-neutralizing substance and the leather undergoing treatment, the device may have a gas exchange device, by means of which active gas exchange can take place between the at least one odor-neutralizing substance and the treatment space. The gas exchange device may then be configured for example as a fan and/or as a compressor.

According to a particularly simple embodiment, it may be envisaged that the at least one odor-reduction reservoir is arranged inside the treatment space. Moreover, the odor-neutralizing substance may for example be bound loosely and/or firmly on or to a wall of the treatment space. It is thus possible to dispense with an additional chamber for the odor-reduction reservoir.

Alternatively or additionally, the at least one odor-neutralizing substance may be arranged in an interchangeable replaceable unit. Therefore particularly simple replacement of the odor-neutralizing substance is possible by replacing the replaceable unit, on reaching the maximum period of use.

To simplify changing the odor-neutralizing substance, the at least one odor-reduction reservoir may have a holder and a, for example the aforementioned, replaceable unit, insertable into the holder and replaceable, with the at least one odor-neutralizing substance. For example, the replaceable unit may be configured as a cartridge and/or as a pad and/or as an odor filter.

According to one embodiment, the at least one odor-neutralizing substance may be dry. Alternatively or additionally, the at least one odor-neutralizing substance may be recyclable, for example may even be compostable. Alternatively or additionally, the odor-neutralizing substance may be reactivatable. For example, reactivation may take place by heating. Alternatively or additionally, the at least one odor-neutralizing substance may be a liquid absorbent material, in particular one that is liquid at a process temperature (e.g. also a mixture and/or a solution of solids in a liquid), which is incorporated in a dry, porous carrier material. Preferably, the carrier material may have an average particle size of 3-8 mm, in particular 3-6 mm.

According to a particularly advantageous embodiment, the at least one odor-neutralizing substance may be at least one or a combination of two or more odor-neutralizing substances selected from the group comprising carbon-containing absorbents, mineral absorbents, coffee, coffee grounds, activated carbon, cyclodextrins, zeolite, zinc compounds, coffee-based activated carbon. Preferably, the odor-neutralizing substance is used in pellet form. The formation of dust may thus be reduced. Especially preferably, the at least one odor-neutralizing substance may have an average particle size of 3-8 mm, in particular 3-6 mm.

According to a further embodiment, the at least one odor-neutralizing substance may be fine-grained and/or pulverulent. Alternatively or additionally, the odor-neutralizing substance may be mixed with a filler. In particular, the particle size of the filler may be greater than or less than the particle size of the odor-neutralizing substance, so that the gas permeability of the odor-neutralizing substance through the filler is increased, dust reduction or prevention being desirable. For example, the filler may be cellulose (in particular antidust-based-cellulose) and/or a polymer and/or a mineral filler, such as zeolite and/or vermiculite. The filler may be free from additives, such as in particular free from flame retardants and/or other chemicals. The average particle size of the filler may be 3-8 mm, in particular 3-6 mm.

According to a further embodiment, the device may have a fragrance reservoir with at least one odorant, wherein a gas-exchange compound is arranged between the treatment space and the fragrance reservoir. It is thus possible to carry out, besides odor reduction, also an odorant treatment with odorants desired by the user. So as better to be able to avoid desired fragrances also being trapped by the odor-neutralizing substance, it may for example be envisaged that the fragrance reservoir is arranged within a, for example circulating, gas stream provided or providable between treatment space and odor-reduction reservoir in the direction of flow after the odor-reduction reservoir and/or in a chamber, for example the aforementioned chamber separated from the treatment space.

The advantages described in relation to the device also apply to the subsequent objects of the invention.

The invention further relates to a replaceable unit with at least one odor-neutralizing substance for use in a holder of an odor reduction reservoir of a device for reducing the odor of tanned leather. For example, it may be an odor-neutralizing substance, as has already been described in detail herein in relation to the device. For example, it may be a device such as is described and claimed herein.

The invention further relates to a kit for retrofitting a tumbling device for tumbling dry leather and/or a drying device for drying tanned leather, comprising at least one replaceable unit, such as is described and claimed herein, and a holder for holding and/or fixing the replaceable unit. Optional, advantageous embodiments may for example be configured by the features of the device.

The invention further relates to a method for reducing the odor of tanned leather, comprising the steps:
providing tanned leather in a, preferably closable, treatment space,
setting up a preferably continuous gas exchange between the treatment space and an odor-reduction reservoir, which has at least one odor-neutralizing substance, in particular such as is described and claimed herein.

As already explained in relation to the device described and claimed herein, the method also has the advantage that it can be integrated particularly easily in known methods for leather manufacture, for example during a drying step and/or during a tumbling step, without altering the course of the other process steps. Sometimes it is even possible to use existing, conventional devices for leather manufacture for implementing the method.

Advantageous embodiments of the invention are described hereunder, which may be combined, either alone or in combination with the features of other optional embodiments, with the features of the independent method claim.

According to one embodiment, active gas exchange can be generated between the treatment space and the odor-reduction reservoir. For example, gas circulation may be set up between the treatment space and the odor-reduction reservoir. This makes it possible to improve gas exchange between the odor-neutralizing substance and the leather and therefore also accelerate odor reduction.

According to a variant, dry leather may be used or it may be envisaged that the leather is dried during odor neutralization.

In order to achieve particularly efficient odor reduction, the leather may be moved within the treatment space. For example, the leather may be tumbled. It may thus be envisaged that all process steps of the method are carried out during usual treatment of the leather in the treatment space.

According to a variant, the odor-reduction reservoir may be placed in the treatment space. The odor-reduction reservoir may then for example be arranged loose in the treatment space and/or may be connected firmly on or to a wall of the treatment space.

Alternatively or additionally, it may be envisaged that the odor-reduction reservoir or a further odor-reduction reservoir is arranged outside the treatment space.

In a particularly sustainable embodiment, it may be envisaged that the at least one odor-neutralizing substance is dry and/or recyclable and/or reactivatable and/or is a liquid absorbent material, which is incorporated in a dry, porous carrier material.

Alternatively or additionally, the at least one odor-neutralizing substance may comprise at least one or a combination of two or more odor-neutralizing substances selected from the group comprising carbon-containing absorbents, mineral absorbents, coffee, coffee grounds, activated carbon, cyclodextrins, zeolite, zinc compounds, coffee-based activated carbon.

In order to endow the leather with a particular fragrance, especially after carrying out the odor reduction, the leather may be treated with at least one odorant arranged in a fragrance reservoir, by setting up a for example continuous gas exchange between the treatment space and the fragrance reservoir.

According to one embodiment of the method, the device as described and claimed herein may be used for carrying out the method.

According to a variant, it may be envisaged that all process steps are carried out without radical-releasing treatment of the leather. In particular, no photolytic treatment and/or ozonolytic treatment and/or electrochemical treatment and/or oxidative treatment and/or thermolytic treatment is carried out. Especially preferably, there is no formation of chromium(VI) compounds. The formation of radicals would have the disadvantage that it might lead to autoxidation on unsaturated fatty acids of the leather itself and/or on any fat-liquoring agents used. In other words it may therefore lead to rancidification, which leads to a negative odor development. This can be prevented by the radical-free treatment of the leather.

According to an advantageous variant, it may be envisaged that the method for odor reduction is applied as part of a method of manufacture of tanned leather, in particular in such a way that odor reduction is carried out during tumbling of the leather, preferably in a drum tumbler. This has the advantage that the total time of a production process, despite additional carrying out of the method described and/or claimed herein, is only lengthened insignificantly, or not at all. Moreover, only slight additional actions are required for carrying out the method for odor reduction as an extra process during the production process. In particular, the method can be carried out during tumbling (also called milling) of the leather.

The invention further relates to a method for retrofitting a tumbling device for tumbling dry leather and/or a drying device for drying tanned leather with an odor-reduction reservoir, which has at least one odor-neutralizing substance.

The invention further relates to the use of coffee and/or at least one substance obtained therefrom, for example such as coffee grounds, for odor reduction of tanned leather. For example, the use may be carried out in a device such as is described and claimed herein, and/or in a replaceable unit such as is described and claimed herein, and/or in a kit such as is described and claimed herein, and/or in a method such as is described and claimed herein.

The invention is now described in more detail on the basis of several embodiment examples, but it is not limited to these embodiment examples. Further embodiment examples result from combining the features of individual or several claims with one another and/or with individual or several features of the embodiment examples.

The figures show:

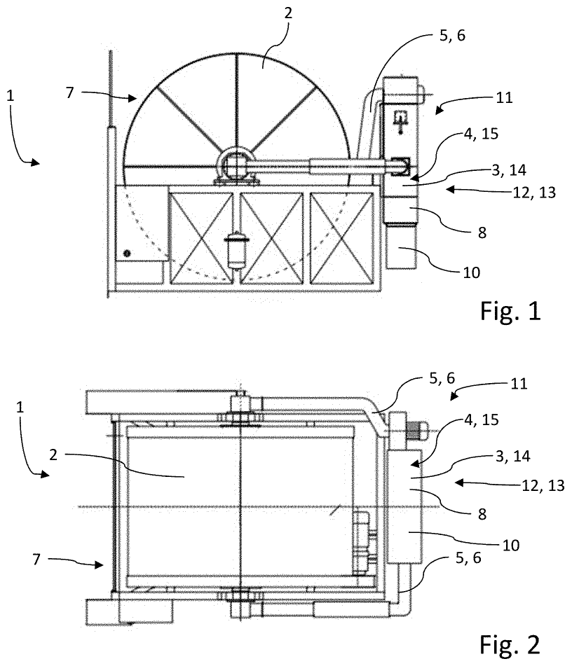

FIG. 1 a simplified schematic side view of a first embodiment of a device according to the invention for reducing the odor of tanned leather, wherein the device is arranged as a tumbling device,

FIG. 2 a longitudinal view of the device from FIG. 1,

FIG. 3 a top view of the device from FIGS. 1 and 2,

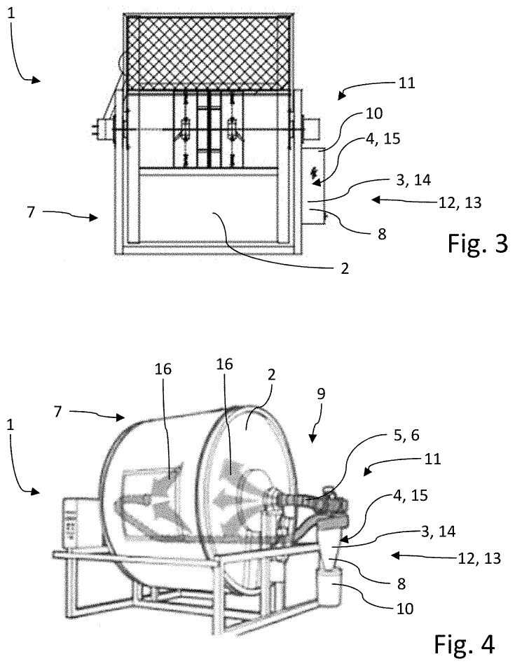

FIG. 4 a simplified schematic perspective view of a further embodiment of a device according to the invention for reducing the odor of tanned leather, wherein gas circulation is indicated with the broad arrows,

FIG. 5 a further perspective view of the device from FIG. 4, wherein the particles generated in the treatment space during leather tumbling are indicated,

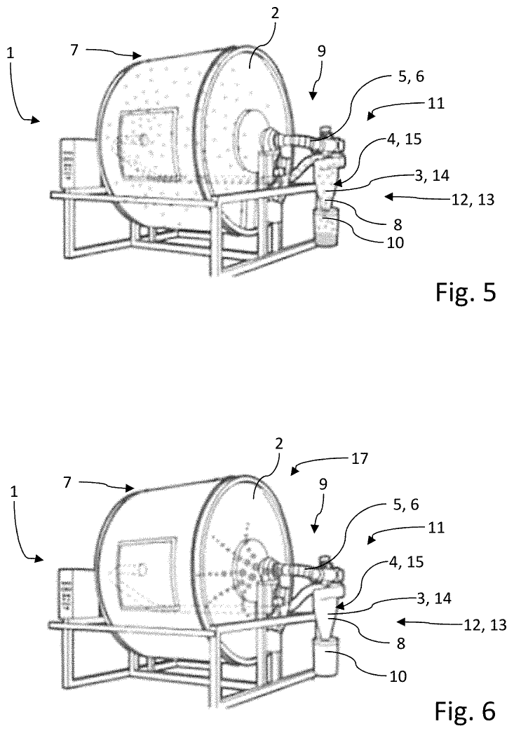

FIG. 6 a further perspective view of the device from FIG. 4, wherein moisture is sprayable in the gas stream and/or the treatment space via a humidifier,

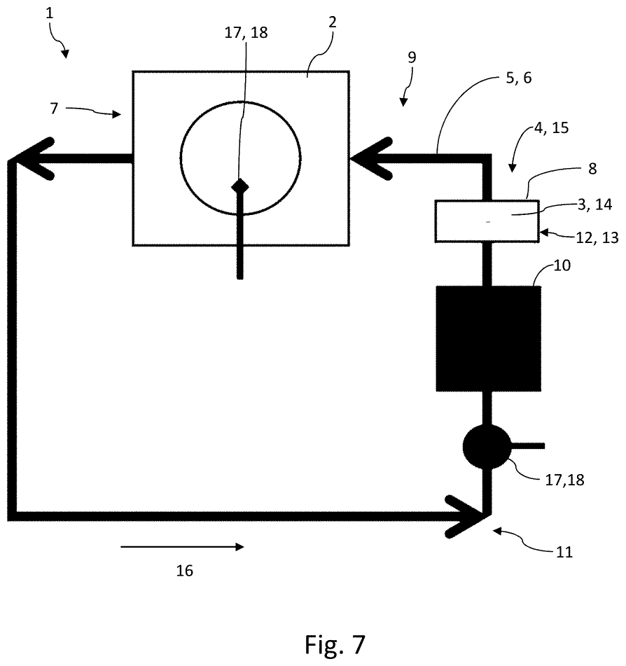

FIG. 7 a schematic representation of a further possible embodiment variant of a device according to the invention.

FIGS. 1 to 7 show several embodiments of a device for reducing the odor of tanned leather, which is designated in each case as 1 throughout.

The device 1 has a treatment space 2, which is arranged for treating leather. The treatment space 2 may for example, as shown in FIGS. 1-7, be configured as a drum tumbler 7.

However, other configurations are also possible, in which the treatment space 2 is for example arranged for drying tanned leather.

The device 1 has at least one odor-reduction reservoir 3, which is arranged outside the aforementioned treatment space 2. The odor-reduction reservoir 3 has at least one odor-neutralizing substance 4, which is arranged inside the odor reduction reservoir 3.

According to an alternative or supplementary embodiment of the device 1, the odor-neutralizing substance 3 may be arranged inside the treatment space 2. What is decisive is that a gas-exchange compound 5 is provided between the treatment space 2 and the odor-reduction reservoir 3, and thus between the odor-neutralizing substance 4 and the leather.

The gas-exchange compound 5 between the treatment space 2 and the odor-reduction reservoir 3 may for example be provided by at least one gas exchange line 6.

The treatment space 2 configured as a tumbling drum is arranged rotatably about a rotation axis. Treatment of the leather is possible by rotation of the treatment space 2. The leather may therefore be rotated together with the treatment space 2, so that it is tumbled in the treatment space 2. During tumbling, odor reduction can take place simultaneously.

The treatment space 2 has a closable opening, via which the tanned leather can be fed into the treatment space 2. The opening may be closed for example by means of a door or hatch.

The odor-reduction reservoir 3 is arranged or configured in a chamber 8 spatially separated from the treatment space 2.

The device 1 has several gas exchange lines 6. A gas exchange line 6 leads from the treatment space 2 to the chamber 8 and a gas exchange line 6 leads from the chamber 8 back into the treatment space 2. Thus, a closed system 9 is set up from the treatment space 2, the gas exchange lines 6 and the chamber 8. Therefore a gas stream and/or gas circulation 16 can be set up inside the closed system 9. Thus, multiple treatment of the gas stream 16 with the odor-neutralizing substance 4 is possible, as the gas stream 16 is led repeatedly through the odor-reduction reservoir 3.

Treatment of the leather within the treatment space 2 may result in separation of particles from the leather. So as to be able to minimize the dust burden of a space in which the device 1 is arranged, the device 1 may have a particle filter 10. The aforementioned gas stream 16 can be filtered by the particle filter 10, so that on completion of treatment of the leather, a high proportion of the particles have been removed from the air inside the treatment space 2 by the particle filter 10.

In order to accelerate gas exchange between the treatment space 2 and the odor-reduction reservoir 3, the device 1 may have a gas exchange device 11. The gas exchange device 11 may for example be configured as a fan and/or as a compressor, wherein the gas exchange device 11 may be integrated in the system 9. As a result, active gas exchange is possible between the at least one odor-reduction reservoir 3 and the treatment space 2.

The odor-neutralizing substance 4 may be arranged in a replaceable unit 12. The replaceable unit 12 has the advantage that it is easier to replace an odor-neutralizing substance that has exceeded its maximum usability. The odor-neutralizing substance 4 may therefore be replaced easily by replacing the complete replaceable unit 12.

So as to be able to fix the replaceable unit 12 in the odor-reduction reservoir 3, the odor-reduction reservoir 3 may have a holder 13, into which the replaceable unit 12 can be inserted. A nonpositive-fit and/or positive-fit connection may be arranged between the holder 13 and the replaceable unit.

The replaceable unit 12 may for example be configured as a cartridge and/or as a pad and/or as an odor filter.

The odor-neutralizing substance 4 is preferably in dry form, so that for example it may be pulverulent. It may be particularly advantageous if the odor-neutralizing substance 4 is recyclable, i.e. reusable. It may then be particularly advantageous if the odor-neutralizing substance 4 is for example reactivatable by heat treatment. When the odor-neutralizing substance reaches its maximum usage time, it is particularly advantageous if the odor-neutralizing substance 4 is compostable, to avoid garbage.

So as to be able to increase the permeability of the odor-neutralizing substance 4 for the gas stream 16, the odor-neutralizing substance 4 may be mixed with a filler. In particular, the particle size of the filler may be greater than or less than the particle size of the odor-neutralizing substance, so that the gas permeability of the odor-neutralizing substance is increased by the filler. The particle size of the filler may be greater than the particle size of the odor-neutralizing material. The filler may be for example cellulose and/or a polymer and/or a mineral filler, such as zeolite. For example, the filler may be cellulose (in particular antidust-based-cellulose) and/or a polymer and/or a mineral filler, such as zeolite and/or vermiculite. The filler may be free from additives, such as in particular free from flame retardants and/or other chemicals. The average particle size of the filler may be 3-8 mm, in particular 3-6 mm.

The odor-neutralizing substance 4 may be for example at least one or a combination of two or more substances 4 selected from the group comprising carbon-containing absorbents, mineral absorbents, coffee, coffee grounds, activated carbon, cyclodextrins, zeolite, zinc compounds, coffee-based activated carbon.

The device 1 may further have a fragrance reservoir 14 with at least one odorant 15 arranged therein. The reservoir 14 may for example be arranged or configured in a chamber 8, in particular in the aforementioned chamber 8 or a further chamber 8. With the odorant 15 it is possible for the leather treated by odor neutralization to be treated with a desired fragrance.

The fragrance reservoir 15 may be arranged downstream in the direction of flow of the odor-reduction reservoir 13, inside a gas stream 16 directed between the treatment space 2 and the odor-reduction reservoir 13.

As shown in FIG. 6, the device 1 may have at least one humidifier 17. The humidifier 17 may for example be configured as at least one nebulizer device 18. By means of the nebulizer device 18 and/or the humidifier 17 it is possible to feed a liquid, in particular water or an aqueous solution, into the gas stream 16 and/or the treatment space 2 for example by sprinkling or spraying. An additional treatment of the tanned leather may thus take place. A sensor for determining moisture, in particular air humidity, may be provided in the treatment space 2. Also preferably, a control unit may be provided, which is arranged for controlling the moisture via the humidifier 17 as a function of the measured moisture, preferably automatically by activation and deactivation of the humidifier 17.

FIG. 7 shows the schematic structure of a further embodiment variant, which basically corresponds to the embodiment variant described above. In addition, the device 1 shown in FIG. 7 has two nebulizer devices 18, which may be configured identically or differently.

A first nebulizer device 18 is assigned to the treatment space 2, for injecting liquid in particular as mist and/or in the form of spray into the treatment space 2. For example, water and/or an additive may be fed into the treatment space 2 and onto the leather being treated therein. The additive may for example be an additional odor-neutralizing substance 4 and/or some other substance for treating leather. In particular, the additive may be odor-neutralizing cyclodextrins, which are for example in aqueous solution. The cyclodextrins may have an additional odor-reducing action. According to an alternative embodiment variant, the odor-reduction reservoir 3 may be replaced by the nebulizer device 18, if this is set up for releasing an odor-neutralizing substance 4.

The at least one nebulizer device 18 may have an outlet, for example a spraying nozzle, which can release liquid in the treatment space 2 and/or in the gas exchange line 6. The liquid may also be transported with the gas stream into the treatment space 2, if direct release in the treatment space 2 is not provided.

In the direction of flow 16 of the gas stream, the nebulizer device 18 assigned to the gas exchange line 6 may be arranged within the gas exchange line 6 before the filter 10 and/or before the odor-reduction reservoir 3 and/or before the fragrance reservoir 14. This has the advantage that the filter 10 filters out solids, such as cyclodextrins, which are introduced into the gas stream 16 by the nebulizer device 18, before the gas stream 16 enters the treatment space 2. This can prevent solids coming into contact with the leather.

### Tests Carried Out

I. First Pilot Test

I.1 Material and Equipment

I.1.1

Sample A: 10 hides (corresponding to crust leather) tanned with a chromium-containing retanning formulation #1 (without treatment for odor reduction as described and claimed herein).

I.1.2

Sample B: 10 hides (corresponding to crust leather) tanned with a chromium-containing retanning formulation #1 (with treatment for odor reduction as described and claimed herein).

I.1.3

Milling drum (tumbling drum) made by the company Erretre.

I.1.4

Activated carbon was used as odor-neutralizing substance. The activated carbon was used in the form of an activated carbon filter.

I.1.5

Filter size: 20 cm×25 cm×3 cm, preferably the filter material may also have a volume of two to three liters.

I.2 Test Procedure

I.2.1 Sample A

(reference example, corresponds to the prior art)

The hides for Sample A were put in a tumbling drum and were tumbled for 4 hours in the tumbling drum at 35° C. and 35% RH.

I.2.2 Sample B

(corresponding to a sample that was produced by means of the invention)

The hides for Sample B were tumbled in the tumbling drum for the same length of time and in the same conditions as for Sample A. In addition, throughout the treatment time in the tumbling drum, gas exchange was arranged between the tanned hides and a filter (1500 cc) containing 700 grams of activated carbon.

I.2.3 Odor Sampling

After the tumbling process, the two samples A and B were treated separately, so that there could not be any corruption of the result.

One odor sample was taken from each of the two samples A and B and was analyzed in an odor test according to VDA 270 C3.

I.2.4 VDA 270 Scoring

In the VDA 270 test, only the odor intensity is determined, on a scale from degree 1 to degree 6, where:
Degree 1: imperceptible
Degree 2: weakly perceptible, but not disturbing
Degree 3: clearly perceptible, but not disturbing
Degree 4: disturbing
Degree 5: very disturbing
Degree 6: unacceptable

I.3 Results

One set of the odor samples taken was evaluated for odor by customers and another set was evaluated in-house at TFL.

I.3.1 Result from customers

Sample A Degree 4

Sample B Degree 3

I.3.2 Result at TFL

Sample A Degree 4

Sample B Degree 3-4

II. Second Pilot Test

II.1 Material and Equipment

II.1.1

Sample C: 10 hides (corresponding to crust leather) tanned with a chromium-free retanning formulation #2 (without treatment for odor reduction as described and claimed herein).

II.1.2

Sample D: 10 hides (corresponding to crust leather) tanned with a chromium-free retanning formulation #2 (with treatment for odor reduction as described and claimed herein).

II.1.3 Further Materials

The other materials correspond to those already used in the first pilot test.

11.2 Test procedure

The test procedure corresponds to the test procedure of the first pilot test.

II.3 Results

One set of the odor samples taken was evaluated for odor by customers and a further set was evaluated in-house at TFL.

II.3.1 Result from Customers

Sample C Degree 3-4

Sample D Degree 3-4

II.3.2 Result at TFL

Sample C Degree 4

Sample D Degree 3-4

III. Third Pilot Test

III.1 Material and Equipment

III.1.1

Sample E: 10 splits (corresponding to crust leather) tanned with a chromium-containing retanning formulation #3 (without treatment for odor reduction as described and claimed herein).

III.1.2

Sample F: 10 splits (corresponding to crust leather) tanned with a chromium-containing retanning formulation #3 (with treatment for odor reduction as described and claimed herein).

III.1.3 Further Materials

The other materials correspond to those already used in the first pilot test.

III.2 Test Procedure

The test procedure corresponds to the test procedure of the first pilot test.

III.3 Results

One set of the odor samples taken was evaluated for odor by customers and another set was evaluated in-house at TFL.

III.3.1 Result from Customers

Sample E Degree 2-3

Sample F Degree 2

III.3.2 Result at TFL

Sample E Degree 3

Sample F Degree 2-3

### LIST OF REFERENCE SYMBOLS

1 device
2 treatment space
3 odor-reduction reservoir
4 odor-neutralizing substance
5 gas-exchange compound
6 gas exchange line
7 drum tumbler
8 chamber
9 system; closed system
10 filter; particle filter
11 gas exchange device
12 replaceable unit
13 holder
14 fragrance reservoir
15 odorant
16 gas stream; gas circulation
17 humidifier
18 nebulizer device

1. A device for odor reduction of tanned leather, comprising a treatment space, which is arranged for drying tanned leather and/or for treating dry leather, and at least one odor-reduction reservoir, wherein the at least one odor-reduction reservoir has at least one odor-neutralizing substance, wherein a gas-exchange compound is arranged between the treatment space and the odor-reduction reservoir, wherein the at least one odor-reduction reservoir is arranged in a chamber separated from the treatment space, which is connected via at least one gas exchange line to the treatment space, in such a way that a closed or closable system of treatment space, gas exchange line and chamber is configured, in which a circulating gas stream can be generated, wherein in operation, thus with movement of the treatment space, the chamber does not move with it, but remains stationary.

2. The device as claimed in claim 1, wherein the treatment space is arranged so that it is movable, wherein leather placed therein is moved along during operation, and/or wherein the treatment space is configured as a drum tumbler for tumbling dry leather, for example as a tumbling drum or drum tumbler, and/or as a drying chamber for drying tanned leather, for example as a drying tunnel, and/or wherein the treatment space has a closable opening.

3. The device as claimed in claim 1, wherein a filter, in particular a particle filter is arranged in a or the chamber and/or in a or the gas exchange line.

4. The device as claimed in claim 1, wherein the device has a gas exchange device, by means of which active gas exchange can be effected between the at least one odor-reduction reservoir and the treatment space, for example wherein the gas exchange device is configured as a fan and/or as a compressor.

5. The device as claimed in claim 1, wherein the at least one odor-neutralizing substance is arranged in an interchangeable replaceable unit.

6. The device as claimed in claim 1, wherein the at least one odor-reduction reservoir has a holder and a replaceable unit that is usable in the holder and is interchangeable, with the at least one odor-neutralizing substance, for example wherein the replaceable unit is configured as a cartridge and/or as a pad and/or as an odor filter.

7. The device as claimed in claim 1, wherein the at least one odor-neutralizing substance is dry and/or recyclable and/or reactivatable and/or is a liquid absorbent material that is incorporated in a dry, porous carrier material, and/or wherein the at least one odor-neutralizing substance is at least one or a combination of two or more substances selected from the group comprising carbon-containing absorbents, mineral absorbents, coffee, coffee grounds, activated carbon, cyclodextrins, zeolite, zinc compounds, coffee-based activated carbon.

8. The device as claimed in claim 1, wherein the at least one odor-neutralizing substance is fine-grained and/or pulverulent and/or wherein the odor-neutralizing substance is mixed with a filler, preferably wherein the particle size of the filler is greater than or less than the particle size of the odor-neutralizing substance, in particular so that the gas permeability of the odor-neutralizing substance is increased by the filler, for example wherein the filler is cellulose and/or a polymer and/or a mineral filler, such as zeolite and/or vermiculite.

9. The device as claimed in claim 1, wherein the device has a fragrance reservoir with at least one odorant, wherein a gas-exchange compound is arranged between the treatment space and the fragrance reservoir, for example wherein the fragrance reservoir is arranged within a gas stream set up between treatment space and odor-reduction reservoir in the direction of flow toward the odor-reduction reservoir and/or in a or the chamber separated from the treatment space; and/or wherein the device has at least one nebulizer device, preferably wherein the device has a first nebulizer device and a second nebulizer device, in particular wherein the first nebulizer device is assigned to the treatment space and/or the second nebulizer device is assigned to a or the gas exchange line.

10. A replaceable unit with at least one odor-neutralizing substance for inserting in a holder of an odor reduction reservoir of a device for odor reduction of tanned leather as claimed in claim 1, preferably wherein the at least one odor-neutralizing substance is at least one or a combination of two or more substances selected from the group comprising carbon-containing absorbents, mineral absorbents, coffee, coffee grounds, activated carbon, cyclodextrins, zeolite, zinc compounds, coffee-based activated carbon.

11. A kit for retrofitting a tumbling device for tumbling dry leather and/or a drying device for drying tanned leather, comprising at least one replaceable unit as claimed in claim 10 and a holder for holding and/or fixing the replaceable unit.

12. A method for reducing the odor of tanned leather by means of a device for odor reduction as claimed in claim 1, comprising the steps:
providing tanned leather in a, preferably closable, treatment space,
setting up a preferably continuous gas exchange between the treatment space and an odor-reduction reservoir, which has at least one odor-neutralizing substance,
wherein a gas circulation is arranged between the treatment space and the odor-reduction reservoir; wherein preferably
dry leather is used or wherein the leather is dried during odor neutralization and/or
the leather is moved, in particular is tumbled, within the treatment space and/or wherein all process steps of the method are carried out during a usual treatment of leather in the treatment space.

13. The method as claimed in claim 12, wherein the at least one odor-neutralizing substance is dry and/or recyclable and/or reactivatable and/or is a liquid material that is incorporated in a dry, porous carrier material, and/or wherein the at least one odor-neutralizing substance comprises at least one or a combination of two or more substances selected from the group comprising carbon-containing absorbents, mineral absorbents, coffee, coffee grounds, activated carbon, cyclodextrins, zeolite, zinc compounds, coffee-based activated carbon.

14. The method as claimed in claim 12, wherein the leather is treated with at least one odorant arranged in a fragrance reservoir, wherein a gas exchange is set up between the treatment space and the fragrance reservoir.

15. The method as claimed in claim 12, wherein all process steps are carried out without radical-releasing treatment of leather, in particular wherein no photolytic treatment and/or no ozonolytic treatment and/or no electrochemical treatment and/or no oxidative treatment and/or no thermolytic treatment is carried out, in particular preferably wherein there is no formation of chromium(VI) compounds.

16. The method as claimed in claim 12, wherein the method for odor reduction is applied as part of a method of manufacture of tanned leather, in particular in such a way that odor reduction is carried out during tumbling of the leather, preferably in a drum tumbler.
